(19) United States
(12) Patent Application Publication
(10) Pub. No.: US 2019/0122163 A1
(43) Pub. Date: Apr. 25, 2019

(54) SYSTEM AND METHOD FOR DELIVERY PAYMENT AND VERIFICATION

(71) Applicant: BOOZ ALLEN HAMILTON INC., McLean, VA (US)

(72) Inventor: Neil Dallas VAUGHAN, JR., Charleston, SC (US)

(73) Assignee: BOOZ ALLEN HAMILTON INC., McLean, VA (US)

(21) Appl. No.: 15/792,093

(22) Filed: Oct. 24, 2017

(51) Int. Cl. G06Q 10/08; G06Q 20/40; G06K 7/14; G06F 21/44; G06K 9/34

(52) U.S. Cl. CPC G06Q 10/083; G06Q 20/401; G06K 2209/01; G06F 21/44; G06K 9/344; G06K 7/1413

(57) ABSTRACT

A method for verifying authorization for package transfer including: scanning attribute data from the package using optical character recognition, the package containing the attribute data and a payment verification code on at least one face; applying a message authentication code algorithm to the attribute data using a software key to reproduce an encoded message authentication code; comparing the reproduced message authentication code to the payment verification code on the at least one face of the package; and verifying that transfer of the package is authorized based on the comparing.

### FIELD

The present disclosure relates to systems, methods and devices for delivery payment and verification.

### BACKGROUND

Customers currently have a number of different options when it comes to payment and verification of items to be shipped or mailed. Most commonly, customers can purchase pre-printed stamps or shipping labels from retail locations that can be affixed to an envelope or package, or they can use an internet-based application to purchase and print postage or shipping labels using the internet and a personally-owned printer. These solutions work well, but can be inconvenient if someone does not have any physical stamps or shipping labels, or who does not have access to a printer.

### SUMMARY

An exemplary embodiment of the present disclosure provides a method for providing a verification code for package transfer, the method comprising: receiving, via the Internet, a request for a payment verification code, the request for the payment verification code including at least attribute data related to a package to be transferred; applying a message authentication code algorithm over the received attribute data using a software key; generating the payment verification code based upon the applying of the message authentication code algorithm to the attribute data, the payment verification code representing payment having been provided for the package to be transferred; and transmitting, via the Internet, the generated payment verification code and a nonce, the generated payment verification code and the nonce being produced for addition to a face of the package to be transferred.

An exemplary embodiment of the present disclosure provides a method for providing payment for package transfer, the method comprising: transmitting, via the Internet, a request for a payment verification code, the request for the payment verification code including at least attribute data related to a package to be transferred; and receiving, in response to the transmitted request, a payment verification code and a nonce, the payment verification code being based upon a result of applying a message authentication code algorithm to the transmitted attribute data and representing payment having been provided for the package, and marking at least one face of the package to be transferred with the received payment verification code and the nonce.

An exemplary embodiment of the present disclosure provides a method for verifying authorization for package transfer, the method comprising: scanning attribute data from the package using optical character recognition, the package containing the attribute data and a payment verification code on at least one face; applying a message authentication code algorithm to the attribute data using a software key to reproduce an encoded message authentication code; comparing the reproduced message authentication code to the payment verification code on the at least one face of the package; and verifying that transfer of the package is authorized based on the comparing.

An exemplary embodiment of the present disclosure provides a computer system comprising: a memory configured to store non-transitory computer-readable instructions for applying a message authentication code algorithm to received data and a software key; and a hardware processor configured to: receive, via the Internet, a request for a payment verification code, the request for the payment verification code including at least attribute data related to a package to be transferred; apply the message authentication code algorithm over the received attribute data using a software key; generate the payment verification code based upon the applied message authentication code algorithm, the payment verification code representing payment having been provided for the package to be transferred; and transmit, via the Internet, the generated payment verification code and a nonce, the generated payment verification code and the nonce being produced for addition to a face of the package to be transferred.

An exemplary embodiment of the present disclosure includes a non-transitory computer-readable storage medium storing instructions which, when executed by a hardware processor of a computing device, cause the hardware processor to perform a method for controlling at least one operation of the computing device, the computing device including a memory device having computer-readable instructions tangibly recorded thereon and a hardware processor configured to execute the computer-readable instructions recorded stored on the memory device, the method comprising: receiving, from a user, a request for a payment verification code, the request for the payment verification code including at least attribute data related to a package, identifying a payment verification code, the payment verification code being based upon a result of applying a message authentication code algorithm to the received attribute data and representing payment having been provided for the package, providing, to the user, the payment verification code and a nonce, the payment verification code and the nonce being produced for addition to a face of the package.

An exemplary embodiment of the present disclosure provides a payment verification device comprising: an optical character recognition (OCR) reader configured to interpret text on at least one face of an package; and a processing device configured to: concatenate the interpreted text; apply a software key code over the concatenated text; generate a payment verification code based upon the attribute data; compare the generated payment verification code to a payment verification code, the payment verification code appearing on a face of the package; and determine that transfer of the package is verified based upon the comparison.

These and other features and advantages of particular embodiments of the system and method for location-based security will now be described by way of exemplary embodiments to which they are not limited.

### BRIEF DESCRIPTION OF THE DRAWINGS

The scope of the present disclosure is best understood from the following detailed description of exemplary embodiments when read in conjunction with the accompanying drawings. Included in the drawings are the following figures:

FIG. 1A illustrates a diagram of a system and method for providing payment and verification information for a package to be transferred;

FIG. 1B depicts an exemplary package to be transferred, attribute data related thereto, and a payment verification code;

FIG. 2 provides a diagram of a system for verifying and transferring a package having a payment verification code;

FIG. 3 is a block diagram illustrating the hardware architecture of a computer system in accordance with an exemplary embodiment; and

FIGS. 4-6 are flow chart diagrams illustrating methods that may be performed by computing devices.

### DETAILED DESCRIPTION

With exemplary embodiments disclosed herein, a customer wishing to mail or ship an item simply can access a service provider's account via a web-enabled device such as a computer or smart phone and enter attributes about an item that they are mailing or shipping, such as destination address, date, services requested, and service fees paid. The customer, upon successful payment processing, is then provided with a short, cryptographically generated alphanumeric code that can be handwritten or printed on the envelope. This code can be inextricably tied to the item's attribute data, so that any attempted modification of its attributes will yield a different code upon physical verification. This alphanumeric code can be subsequently used by the service provider's processing facilities to verify that the postage or service fee present on the item being processed is valid and has been paid for, and that the information on the item is authentic and unable to be repudiated.

In order to use this method, a customer can satisfy simple requirements of establishing an online account with the service provider and registering a valid form of payment with their account.

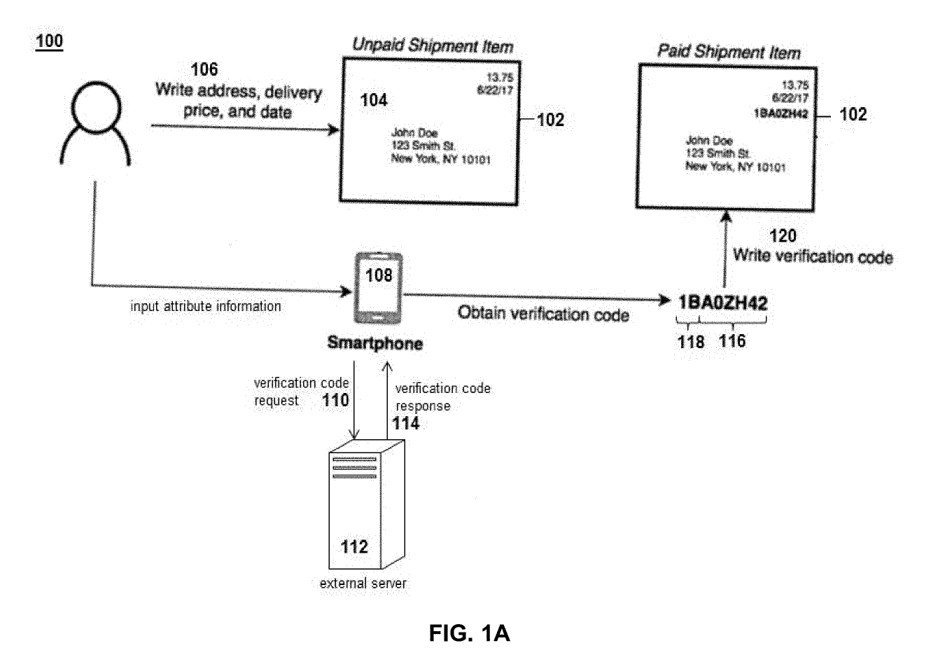

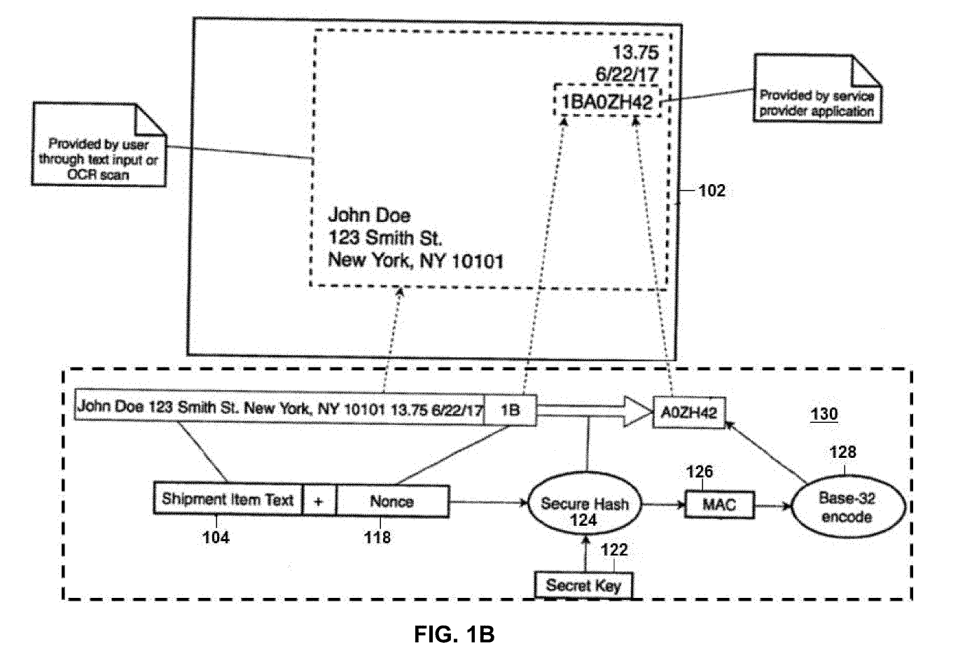

FIG. 1A provides an overview of methods and systems according to exemplary embodiments of the present disclosure. In a method 100, a package 102 to be transferred may be associated with certain attribute data 104 in an initial step.

Attribute data 104 may include, for instance, destination address information, return address information, a postage value, a date (e.g., a mail date), service information (e.g., “Overnight Delivery”, “Insurance”, “Delivery Confirmation”), a user-selected code word or reference number, and/or other information associated with one or more faces of a package to be transferred (e.g., package dimensions, size information, etc.). The attribute data 104 may be provided (e.g., printed, handwritten, etc.) at step 106 on a face of the package 102.

The attribute data 104 may be input into computing device 108 via an input device or user interface (e.g., a keyboard, touch screen, camera, etc.). In some embodiments, the attribute data 104 may be captured by a camera of computing device 108 (e.g., using optical character recognition (“OCR”) technology). In some embodiments attribute data 104 may be captured automatically by known technologies including, for example, optical character recognition (OCR) such as the OCR used with known barcode recognition systems currently associated with business shipping programs used for shipment management. The attribute data can then be subsequently sent to a system interface managed by the service provider. The computing device 108 may be, for instance, a mobile computing device (e.g., a laptop, a smartphone, etc.) or a stand-alone device (e.g., a desktop computer, a kiosk, etc.).

At least some of the attribute data may be transmitted via a request for a payment verification code sent to an external computer system such as external server 112, e.g., via the Internet, as part of a request for a payment verification code 110.

In response, to the transmitted request 110, a response 114 includes a payment verification code 116 and a nonce 118, the response being received from the external server 112. In alternative embodiments, the request may contain a customer-specific code word or reference number that, combined with the rest of the attribute data, can be verified to be unique within the service provider's system. The attribute data can be modified to include the customer-specific code or reference number, and then used to generate the payment verification code. In such embodiments, the nonce is not required and the payment verification code may be the only data received from the external server 112. The payment verification code 116 may be based upon a result of applying a message authentication code algorithm to the transmitted attribute data. In exemplary embodiments, the payment verification code 116 may represent payment having been provided for deliver of the package 102.

The payment verification code 116 and nonce 118 can be generated by the external server 112 based upon a result of applying a message authentication code algorithm to at least some of the attribute data 104, as will be described herein. The payment verification code 116 may represent authorization for transfer of the package 112. For instance, the payment verification code 116 may represent that payment has been provided for delivery of the package 112.

The payment verification code 116 received by the computing device 108 may be affixed at a step 120 (e.g., hand-written, printed, etc.) directly or indirectly on a face of the package 112. For instance, the payment verification code 120 may be handwritten by a user on the face of an envelope. As additional examples, the payment verification code 116 can be printed onto a sticker to be placed on the package 102, printed directly onto a face of the package 102, stamped onto the package 102, etc. In addition to the payment verification code 116, nonce 118 may be affixed to the face of the package 102 in a similar or different manner than the payment verification code 116.

In some embodiments, the payment verification code 116 and/or the nonce 118 may be provided in a specified location such as an upper right hand corner of a face of the package 102. In some embodiments the payment verification code 116 and the nonce 118 may be provided beneath additional information (e.g., a postage value and/or a shipping date). In some embodiments, the payment verification code 116 and the nonce 118 can be provided on the same or a different face of the package 102 in any location. In exemplary embodiments, the payment verification code 116 and/or the nonce 118 can be provided on a face of the package other than the face containing at least some of the attribute information 104.

In exemplary embodiments, the request 110 for a payment verification code 116 can include payment information (e.g., one or more of credit card information, bank account information, e-wallet information, information related to an account associated with the external server 112, coupon information, information related to third party funding entity, etc.). In exemplary embodiments, the request 110 for a payment verification code 116 can include information related to the package such as a postage value (e.g., a flat-fee amount, an amount based on a package weight), a package weight enabling a postage value to be calculated, etc. In exemplary embodiments the response 114 with the payment verification code 116 may be provided subsequent to payment information of a user being verified by the external server 112. In exemplary embodiments, the response 114 can be provided prior to payment information verification. In exemplary embodiments, the response 114 may be a denial to provide a payment verification code, for instance, the payment information transmitted with request 110 is not verified.

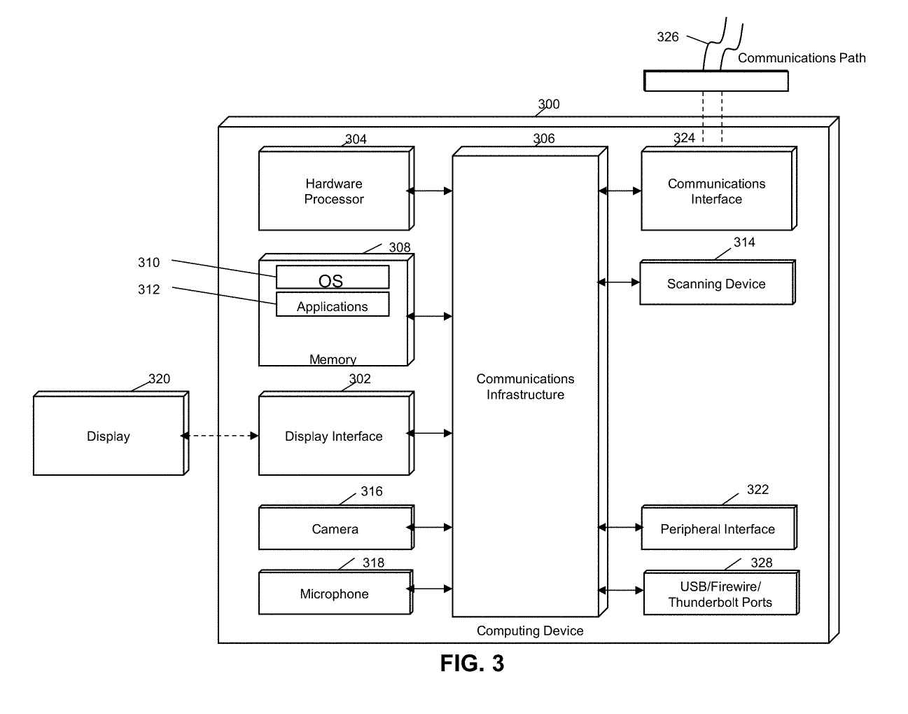

Computing device 108 can include architecture similar to the computing device depicted in FIG. 3. The computing device 108 can be, for example, a mobile computing device (e.g., a laptop, a smartphone, etc.), a stand-alone kiosk, a desktop computer, etc. Computing device 108 can include a hardware processor (e.g. with reference to FIG. 3, similar to the hardware processor 304 depicted in computing device 300 of FIG. 3) and a memory (e.g. similar to the memory 308 depicted in computing device 300 of FIG. 3).

In exemplary embodiments, the computing device 108 can access (e.g. in an internal memory, external memory, via a communications path 326 as depicted in FIG. 3, etc.) instructions stored on a non-transitory computer-readable storage medium (which may be internal to the computing device 108 or external thereto). The instructions can, when executed by a hardware processor of the FIG. 1A computing device 108, cause the hardware processor to perform a method for controlling at least one operation of the computing device 108. The computing device can include the memory device (e.g., the non-transitory computer readable storage medium) or may access an external memory device having the computer-readable instructions stored thereon.

The computing device 108 may receive, from a user, the request 110 for a payment verification code 116, including at least some attribute data 104 related to a package 102. Based upon the received request 110, the computing device 108 may identify a payment verification code 116 (e.g., by internally running an algorithm such as a message authentication code algorithm disclosed herein, by communicating with an external computing system, such as external server 112, etc.), based upon the application of a message authentication code algorithm and representing that the package 102 is authorized to be transferred (e.g., due to verification that the package 102 transfer has been funded).

The computing device 108 executing the instructions may provide to the user (e.g., by displaying on a display of a computing device similar to FIG. 3 display 308, etc.) the FIG. 1A payment verification code 116 and the nonce 118 in a format capable of being added to a face of the package 102.

In exemplary embodiments, the computing device 108 may be configured to load instructions for, e.g., requesting the payment verification code, identifying the payment verification code, and providing the payment verification code (e.g., by displaying, audibly, etc.) into the memory of the computing device 108 (e.g., via the Internet, from an external memory or device, etc.). In exemplary embodiments, the computing device 108 can execute the instructions as part of an application stored in the memory of the computing device 108.

In exemplary embodiments payment information (e.g., credit card account information, etc.) can be transmitted to an external entity (e.g., as part of request 110) prior to the identification of a payment verification code 116. In exemplary embodiments, an indication of payment information being valid may be received by the computing device 108 and the payment verification code 116 may be generated in response. In exemplary embodiments, an indication of payment information being valid may be received by the computing device 108 as part of the response 114 (e.g., the payment verification code 116 and nonce 118 may be provided as representative of the payment information being valid and the package 102 transfer having been funded).

FIG. 1B depicts an exemplary package 102 to be transferred and a method 130 performed, e.g., via an external computer system such as computer system 112. Alternatively, the method 130 can be performed at the computing device 108 in exemplary embodiments.

The method 130 can include receiving (e.g., via the Internet or as local input) a request 110 for a payment verification code 116, the request for the payment verification code including at least attribute data 104 related to a package 102 to be transferred. The attribute data 104 can include some or all of the text appearing on one or more faces of the package 102.

The method 130 can include applying a message authentication code algorithm 124 represented for example, as a secure hash function, over (at least some of) the received attribute data 104 and, optionally, a nonce 118, using a software key which can be a secret key 122. The nonce can be created and annexed by the service provider, or can be supplied by the user in a manner as discussed previously with respect to a customer-specific code. The nonce 116, which can be provided by the service provider, or by the user, can then be detected in any manner as described with regard to the payment verification code. The method 130 can include generating the payment verification code 116 based upon the applying of the message authentication code algorithm 124 to the attribute data 104 (and optionally, the nonce 118), the payment verification code 116 representing authorization having been provided for the package 102 to be transferred (e.g., payment having been verified for the package transfer such as a pre-defined monthly payment, credit card charge, etc.).

The method 130 can include transmitting (or providing if locally performed) (e.g., via the internet), the generated payment verification code 116 and, optionally a nonce 118, the generated payment verification code 116 and nonce 118 being produced in a format capable of addition to a package 102 to be transferred (e.g., by being placed on one or more faces of the package 102).

In exemplary embodiments, the attribute data 104 to which the message authentication code algorithm is applied 124 can include postage information representing an amount of postage purchased by a user in the request for a payment verification code 116. The amount of postage can be included in the request for a payment verification code.

In exemplary embodiments, the application of the message authentication code algorithm 124 and software key 122 may provide a message authentication code (MAC) 126. The message authentication code may be, for example, a 30-bit message authentication code, a 40-bit message authentication code, or a code of any desired length. A smaller length message authentication code is more easily transcribed manually, and as long as the service provider's software key is not publicly exposed, forging valid message authentication codes is infeasible even with relatively small sizes.

In exemplary embodiments, the message authentication code 126 may be encoded with Base-32 encoding 128 to provide the payment verification code 116. In embodiments, the payment verification code may be, for instance, a 6 character alphanumeric string for a 30-bit message authentication code, an 8 character alphanumeric string for a 40-bit authentication code, or a code of any desired length.

In exemplary embodiments, generating of the payment verification code 116 can include encoding the message authentication code using Base-32 encoding.

In exemplary embodiments, payment verification code 116 and nonce 118 can be provided to a computing device other than computing device 108 from which a request 110 for a payment verification code was received.

In an exemplary embodiment, the message authentication code algorithm may be executed over concatenated mail piece data (e.g., street address and/or ZIP code, postage/shipping charges, and/or mailing date, etc.) and, optionally, the nonce or a customer-supplied “code word” using a secret key (e.g., accessible only to an entity which provides the payment verification code, for example, the U.S. Postal Service, a private shipment company, a retailer, etc.).

In an exemplary embodiment, the payment verification code 116 can be generated using the KMAC128 function defined in SHA-3 Derived Functions: cSHAKE, KMAC, TupleHash, and ParallelHash, available at http://nvlpubs.nist.gov/nistpubs/SpecialPublications/NIST.SP.800-185.pdf, or any other suitable and desired function.

For example, the payment verification code based on at least some attribute information 104 associated with a package 102 to be transferred and received by a computing device (e.g., such as external computer system 112) can be generated on the basis of:

A provider secret key K of key_size=256 bits in hexadecimal (base 16) format:
404142434445464748494a4b4c4d4e4f505152535455565758595a5b5c5d5e5f

Exemplary package information (package_data) (e.g., at least some attribute data 104 received by a device executing the message authentication code algorithm) in ASCII format (with nonce “1B”) could appear as follows:
13.75
6/22/17
123 SMITH ST
NEW YORK
NY
10101
1B

Exemplary package data in hexadecimal format could appear as:
31332e37350d0a362f32322f31370d0a31323320534d4954482053540d0a4e455 720594f524b0d0a4e590d0a31303130310d0a3142

For a requested output length (output_length) of MAC:
30-bits;

applying KMAC function, defined within this context as:
KMAC128(K, key_size, package_data, output_length);

to actual parameter values for the above-described exemplary package
KMAC128(40414243 . . . , 256, 31332e37 . . . , 30);

would, for example, result in MAC (30-bit) in binary format:
10101 11101 01010 00110 11100 10111

Encoding with Base-32 encoding, using the following encoding table:

| Base-32 | Binary |
|---|---|
| 0 | 00000 |
| 1 | 00001 |
| 2 | 00010 |
| 3 | 00011 |
| 4 | 00100 |
| 5 | 00101 |
| 6 | 00110 |
| 7 | 00111 |
| 8 | 01000 |
| 9 | 01001 |
| A | 01010 |
| B | 01011 |
| C | 01100 |
| D | 01101 |
| E | 01110 |
| F | 01111 |
| G | 10000 |
| H | 10001 |
| J | 10010 |
| K | 10011 |
| M | 10100 |
| N | 10101 |
| P | 10110 |
| Q | 10111 |
| R | 11000 |
| S | 11001 |
| T | 11010 |
| V | 11011 |
| W | 11100 |
| X | 11101 |
| Y | 11110 |
| Z | 11111 |

Would resulting in an exemplary Base-32 encoded payment verification code as follows:
NXA6WQ

The payment verification code NXA6WQ generated in the above-described example can be, e.g., prepended or appended with nonce “1B” and, e.g., displayed to (if locally derived) or transmitted to a user (e.g. to computing device 108) for display thereon. The payment verification code and nonce may be written (e.g. as “1BNXA6WQ”) on the face of a package to be transferred, such as package 102.

In exemplary embodiments such as that described herein, security against fraudulent transfer of packages is significant as there are 2³⁰ possible combinations for the generated payment verification code. In exemplary embodiments (e.g., such as those where a financial charge against a user's account is generated each time a payment verification code is requested), the payment verification code runs a low risk of being attacked.

As an example of the sufficiency of security of the foregoing example, a potential attacker who attempted to “spam” physical pieces of mail with many different postage verification codes in order to “happen upon” a collision would need to send a very high number of mail pieces per each successful match. For instance, using a 30-bit MAC, the probability of 5,000 mail pieces yielding a single hash collision is 1.1%. For 10,000 mail pieces, it is 4.6̂. In practical terms, to take advantage of accidental collisions, the attacker would need to mail nearly 10,000 non-deliverable mail pieces in order to have a single-digit chance that he or she would get one “free” mail piece delivered successfully. In addition, to enhance security, limited attribute information within a range (or ranges) of specified data, e.g. a mailing date range, physical address range and/or postage value range as part of the attribute information included in the generation of the payment verification code in a manner, can be specific to mitigate possible attack vectors, e.g., by valued attribute information being constrained to a limited range of dates (i.e, dates too far in future/past will not suffice), a limited number of valid street addresses and/or zip code identifiers, and/or a constraint on the format of the postage value.

Additional security safe-guards can be put in place to guard against attacks and enhance security of the herein described methods and systems. For instance, a single software key per zip code, induction facility, etc. can be implemented in the generation of the payment verification code (e.g., so that postage purchased from one location cannot be successfully inducted at another since each location would have its own key, resulting in a different payment verification code for the same attribute data). As another example, the software key can be rotated to reduce the risk that it “leaks” thereby enabling “free postage,” etc. for an extended period of time. As another example, the postage verification code can be increased in length (e.g., to 8 characters), thereby providing a 40-bit (or greater) message authentication code increasing the possible number of unique message authentication codes over 6 character postage verification codes by a factor of 1,000.

As another example of a message authentication code algorithm, any keyed-hash message authentication code algorithm can be substituted for the KMAC algorithm described. The resulting code can be truncated (i.e., taking a subsequence of the code) in order to achieve a smaller length payment verification code, to be more easily transcribed on a package or mailpiece. Other standard HMAC algorithms, such as SHA-256, produce outputs with constant length (in the case of SHA-256, 256 bits), unlike KMAC, which allows one to specify the output length any makes truncating the result less of an issue.

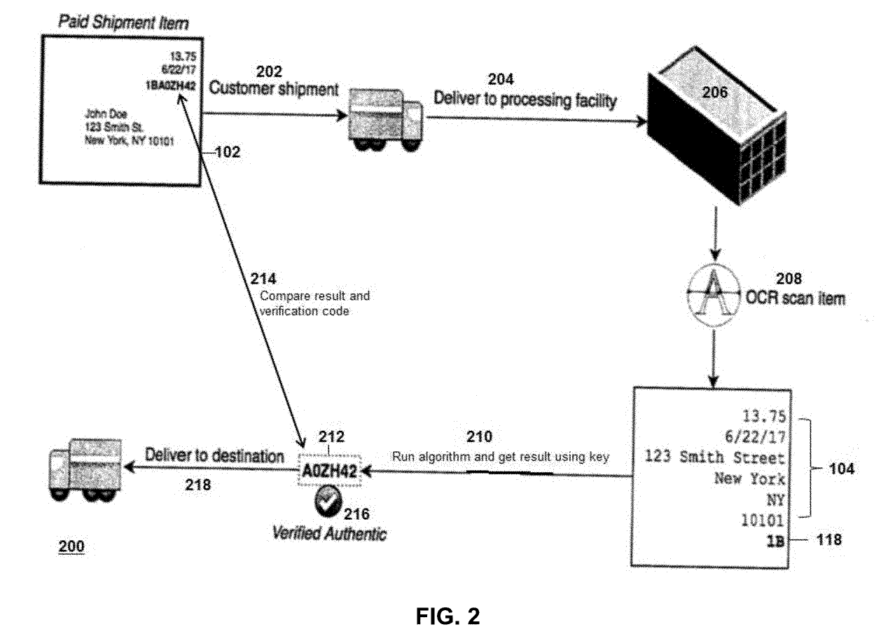

FIG. 2 provides a diagram of a system and method 200 for verifying and transferring a package 102 having a payment verification code 116 affixed thereto.

Method 200 can include a step 202 of placing a package 102 to be transferred in a mail stream and delivering 204 the package 102 to be transferred to a processing facility 206. At the processing facility (or another location) a scanning device 208 can be implemented to scan attribute data 104 from the package 102 using optical character recognition 108, the package 102 containing the attribute data 104 and a payment verification code 116 on at least one face. The data from the face of package 102 may be entered into a computing system via additional or alternative methods other than scanning one or more faces of the package 102 (e.g., manually input, etc.). Although postage value verification systems are known (e.g., such as those available from Toshiba, Pitney Bowes and others), the present system allows such verification to be performed based on the user-applied payment verification code.

The OCR-recognition can rely upon, e.g., relative positioning of text (such as the attribute data 104, payment verification code 116 and nonce 118) on one or more faces of a package 102. For example, the top-right corner of a face of package 102 may include a postage value (e.g. in decimal format), mailing date (e.g., in MM/DD/YYYY format), and a customer supplied “code word” (and/or a payment verification code 116 and/or nonce 118). The middle of a face of a package 102 may include, e.g., a street address, a city and state, and/or a ZIP code. In alternative embodiments, the payment verification code may be placed, e.g., in the bottom-right corner of the face of package 102 or in any other location thereon.

In exemplary embodiments, the scanning device can scan “service” information from the face of a package 102 (e.g. such as “delivery confirmation”). For instance, a user may have been instructed, e.g., during the purchase of payment for transfer of a package, to include “delivery conf” in a certain place on the package 102. The postage verification code generated and provided to the user for placement on package 102 may have included this text as part of the input into its message authentication algorithm. Once the package 102 is OCR-scanned and the result data is sent to the postage processing software, because the text “delivery conf” has special meaning, it may be processed similarly to a standard delivery confirmation barcode (e.g., necessitating an additional physical delivery confirmation barcode to be subsequently printed on the package). In exemplary embodiments, package delivery agents may have the ability to OCR-scan packages 102 during their routes in order to report mail delivery status.

The method 200 can include applying a message authentication code algorithm in step 210 to the attribute data 104 using a software key 122 to reproduce an encoded message authentication code (e.g., using base-32 encoding) 212. The method can include a step 216 of comparing the reproduced encoded message authentication code 212 to the payment verification code 116 on the at least one face of the package 102 and verifying that transfer of the package is authorized based on the comparing step 216.

Upon verification, the method 200 can include a delivering step 218 for delivering the package 102 to a destination printed on a face thereon.

The attribute data in the method 200 to which the message authentication algorithm is applied in step 210, can include, e.g. at least one of a postage value, an address, and a date. The attribute data 104 used in step 210 is similar to the attribute data 104 from which the payment verification code 116 is generated and provided to a user for placement on the face of a package (e.g., as in method 100).

In exemplary embodiments, the scanned payment verification code was, for example, hand-written on the face of the package to be transferred. In exemplary embodiments, the scanning of the attribute data 104 can include processing the scanned attribute data to identify distinct text components using relative positioning of each text component. The distinct text components can include at least one of a postage value, a mailing date, a street address, a city and state, a zip code, and the payment verification code.

In exemplary embodiments, the message authentication code is for example, encoded in base-32 alphanumeric characters as already noted. The message authentication code algorithm is for example, configured to generate a 30-bit message authentication code. In other embodiments, the message authentication code algorithm is configured to generate a 40-bit message authentication code.

A payment verification device, may be a computing device corresponding to some or all of the components identified in FIG. 3. The payment verification device can include an optical character recognition (OCR) reader configured to interpret text on at least one face of an package; and a processing device configured to: concatenate the interpreted text; apply a software key (e.g., secret code) over the concatenated text; generate a payment verification code (or encoded message authentication code) based upon the attribute data; compare the generated payment verification code to a payment verification code appearing on a face of the package; and determine that transfer of the package is authorized based upon the comparison.

In exemplary embodiments, the OCR reader is configured to interpret at least attribute data and a payment verification code from the at least one face of the package.

In exemplary embodiments, the processing device concatenates the attribute data and does not concatenate the payment verification code.

The OCR reader can, for example, be configured to interpret a nonce value from the at least one face of the package and wherein the processing device uses the nonce value to generate the payment verification code.

FIG. 3 is a block diagram illustrating exemplary hardware architecture of a computer system 300 in accordance with an exemplary embodiment. A person having ordinary skill in the art may appreciate that embodiments can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the herein described embodiments.

A hardware processor device as discussed herein may be a singe hardware processor, a plurality of hardware processors, or combinations thereof. Hardware processor devices may have one more processor “cores.” The term “computer program medium,” “non-transitory computer readable medium,” and “computer usable medium” as discussed herein are used to generally refer to tangible media such as a memory device 308.

Various embodiments of the present disclosure are described in terms of the exemplary computing device 300. For instance, embodiments of computing device 108 and scanning devices discussed herein may be illustrated by computing device 300. The scanning devices disclosed herein may be part of a computer system 300 or separate therefrom (e.g., may communicate with a computer system similar to 300 via communications path 326). After reading the present disclosure, it will become apparent to those skilled in the art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, the order of operations may be rearranged without departing from the spirit of the disclosed subject matter.

Hardware processor 304 may be a special purpose or a general purpose processor device. The hardware processor device 304 may be connected to a communication infrastructure 306, such as a bus, message queue, network, multi-core message-passing scheme, etc. The network may be any network suitable for performing the functions as disclosed herein and may include a local area network (LAN), a wide area network (WAN), a wireless network (e.g., Wi-Fi), a mobile communication network, a satellite network, the Internet, fiber optic, coaxial cable, infrared, radio frequency (RF) or any combination thereof. Other suitable network types and configurations will be apparent to persons having skill in the relevant art. The computing device 300 may also include a memory 308 (e.g., random access memory, read-only memory, etc.), and secondary (internal or external) memories (not shown). The memory 308 may be read from and/or written to in a well-known manner. In an embodiment, the memory 308 may be a non-transitory computer readable recording medium.

Data stored in the computing device 300 (e.g., in the memory 308 and/or the secondary memory (not shown)) may be stored on any type of suitable computer readable media, such as optical storage (e.g., a compact disc, digital versatile disc, Blu-ray disc, etc.), magnetic tape storage (e.g., a hard disk drive), or solid-state drive. In embodiments, an operating system 310 and one or more applications 312 may be stored in memory 308.

A secondary memory may include, e.g., a hard disk drive, a removable storage drive, etc.

In an exemplary embodiment, the data may be configured in any type of suitable database configuration, such as a relational database, a structured query language (SQL) database, a distributed database, an object database, etc. Suitable configurations and storage types will be apparent to persons having skill in the relevant art.

The computing device 300 may also include a communications interface 324. The communications interface 324 may be configured to allow software and data to be transferred between the computing device 300 and external devices. Exemplary communication interfaces 324 may include a modem, a network interface (e.g., an Ethernet card), a communications port, a PCMCIA slot and card, etc. Software and data transferred via the communications interface 324 may be in the form of signals, which may be electronic, electromagnetic, optical, or other signals as will be apparent to persons having skill in the relevant art. The signals may travel via a communications path 326, which may be configured to carry the signals and may be implemented using wire, cable, fiber optics, a phone line, a cellular phone link, a radio frequency link, etc.

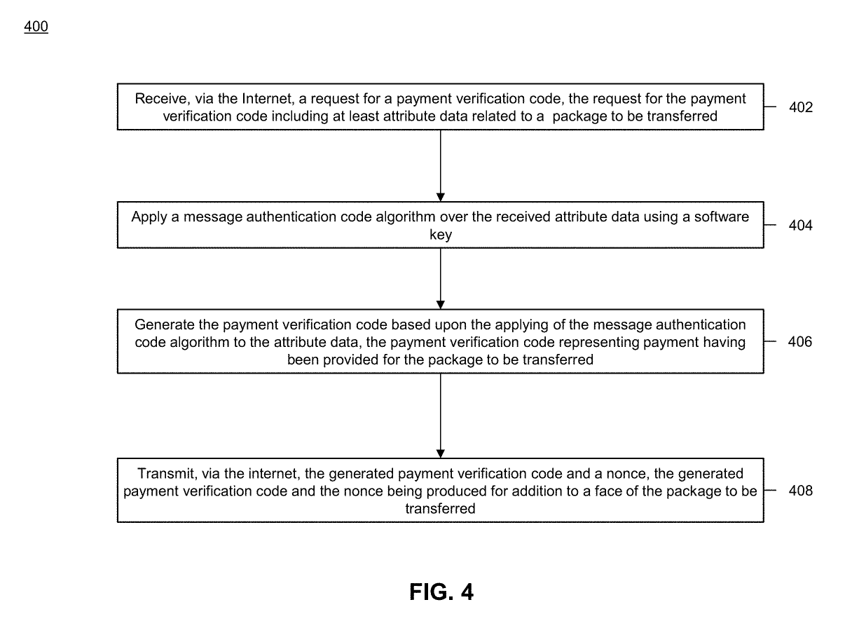

Computer program medium and computer usable medium may refer to memories, such as memory 308 and any other memories (not shown), which may be memory semiconductors (e.g., DRAMs, etc.). These computer program products may be means for providing software to the mobile computing device 300. Computer programs (e.g., computer control logic) may be stored in the memory 308 and/or additional memories (not shown). Computer programs may also be received via the communications interface 324. Such computer programs, when executed, may enable computing device 300 to implement the present methods as discussed herein. For example, the computer programs, when executed, may enable hardware processor device 304 to implement the methods illustrated by FIGS. 4-6, or similar methods, as discussed herein. Accordingly, such computer programs may represent controllers of the computing device 300. Where the present disclosure is implemented using software, the software may be stored in a computer program product or non-transitory computer readable medium and loaded into the computing device 300 using a removable storage drive or communications interface 324.

The computing device 300 may also include various hardware devices, such as a scanning device 314 (e.g., a bar code reader, a QR code reader, etc.), a camera 316, a microphone 318, a display 320, a peripheral interface 322, input/output ports 328 (e.g., USB, firewire, thunderbolt ports, etc.), etc. These devices may be implemented as part of the computing device 300 or may be external to the computing device 300 and communicate with computing device 300 via, e.g., communications pathway 326.

The computing device 300 may also include a display interface 302 that outputs display signals to a display unit 320, e.g., LCD screen, plasma screen, LED screen, DLP screen, CRT screen etc.

FIG. 4 is a flow chart diagram illustrating a method 400 that may be performed by a computing device, such as by the FIG. 3 hardware processor 304 of computing device 300, according to an exemplary embodiment of the present disclosure.

According to an exemplary embodiment in FIG. 4, step 402, the FIG. 3 computing device 300 is configured to receive (e.g., via communications pathway 326), via the Internet, a request for a payment verification code, the request for the payment verification code including at least attribute data related to a package to be transferred. In FIG. 4 step 404, the FIG. 3 computing device 300 is configured to apply a message authentication code algorithm over the received attribute data using a software key. In a step 406, the computing device 300 is configured to generate the payment verification code based upon the applying of the message authentication code algorithm to the attribute data, the payment verification code representing payment having been provided for the package to be transferred.

In FIG. 4 step 408, the FIG. 3 computing device 300, is configured to transmit, via the internet, the generated payment verification code and a nonce, the generated payment verification code and the nonce being produced for addition to a face of the package to be transferred. In exemplary embodiments, these functions may be performed locally (e.g., at a kiosk located in a postal facility which a user may access, etc.). In some embodiments, these functions may be performed by computing device 108 (e.g., a smart phone, a kiosk with which a user interacts, etc.)

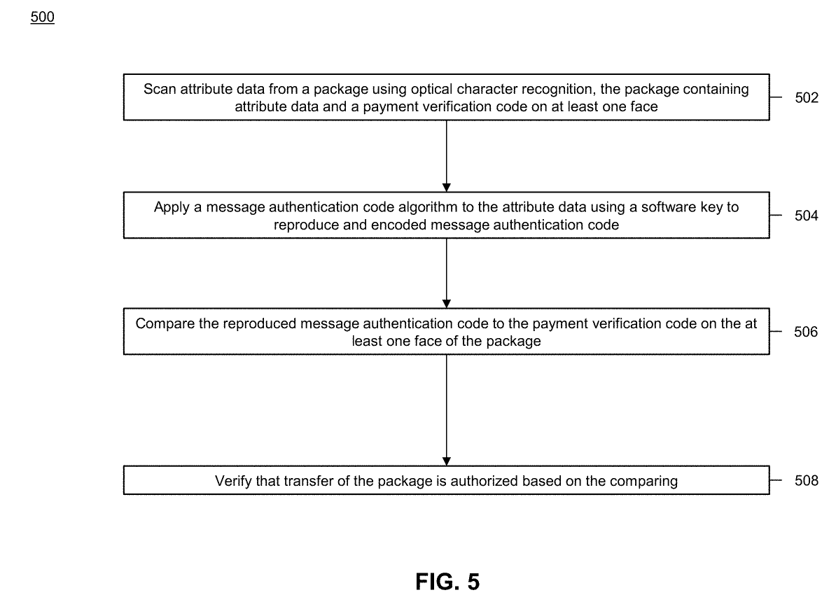

FIG. 5 is a flow chart diagram illustrating a method 500 that may be performed, e.g., by a hardware processor of FIG. 3 computing device 300 (e.g., similar to hardware processor 304). In an exemplary embodiment, in FIG. 5 step 502, a scanning device (e.g. 314, which may be internal or external to a computing device such as computing device 300), may scan attribute data from a package using optical character recognition, the package containing attribute data and a payment verification code on at least one face. A hardware processor (external (e.g., part of a separate scanning device 314) or internal to computing device 300) may interpret the scanned data (e.g. using optical character recognition), and may apply a message authentication code algorithm to the attribute data using a software key to reproduce an encoded message authentication code in a step 504.

In step 506, a hardware processor may compare the reproduced message authentication code to the payment verification code on the at least one face of the package and in a step 508, a hardware processor may verify that transfer of the package is authorized (e.g. based upon the comparison). Any or all of these steps may be performed in an external scanning device 314 having its own hardware processor and/or in a hardware processor 304 of computing device 300.

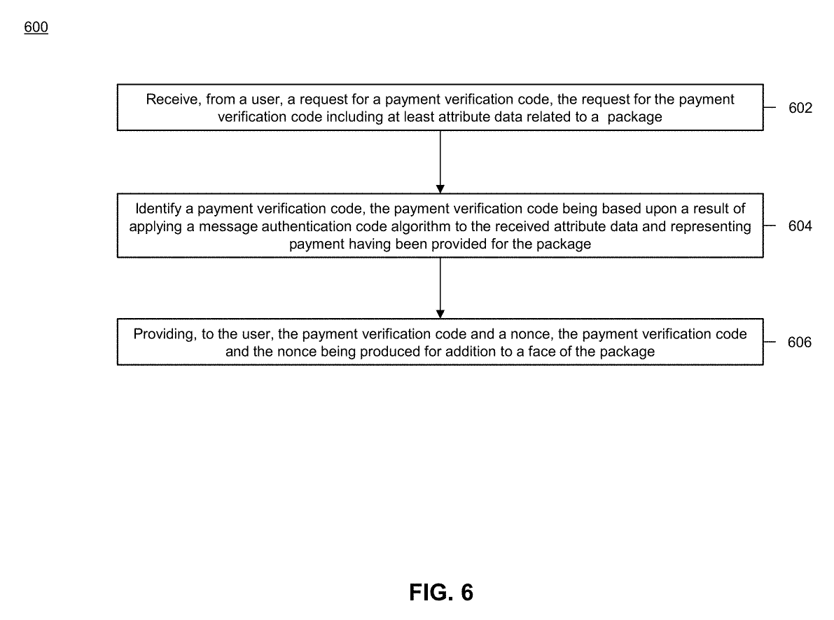

FIG. 6 is a flow chart diagram illustrating a method 600 that may be performed by a hardware processor (such as FIG. 3 hardware processor 304) of a computing device (e.g., FIG. 1 computing device 108). In an exemplary embodiment, computing device 108 may receive, from a user, a request for a payment verification code, the request for the payment verification code including at least attribute data related to a package in a step 602.

In FIG. 6 step 604, the FIG. 1 computing device 108 may identify a payment verification code (e.g., by communicating with an external device, locally by a hardware processor, etc.), the payment verification code being based upon a result of applying a message authentication code algorithm to the received attribute data and representing payment having been provided for the package.

In FIG. 6 step 606, the FIG. 1 computing device 108 may provide, to the user, the payment verification code and a nonce, the payment verification code and the nonce being produced for addition to a face of the package. The payment verification code and the nonce may be, e.g., displayed to a user on a display of computing device 108 (e.g., similar to a display 320).

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for providing a verification code for package transfer, the method comprising:
receiving, via the Internet, a request for a payment verification code, the request for the payment verification code including at least attribute data related to a package to be transferred;
applying a message authentication code algorithm over the received attribute data using a software key;
generating the payment verification code based upon the applying of the message authentication code algorithm to the attribute data, the payment verification code representing payment having been provided for the package to be transferred; and
transmitting, via the Internet, the generated payment verification code and a nonce, the generated payment verification code and the nonce being produced for addition to a face of the package to be transferred.

2. The method of claim 1, wherein the attribute data includes at least one of destination address information, a postage value, a date, and service information.

3. The method of claim 1, wherein the request for payment verification includes payment information for purchase of postage in an amount corresponding to postage value.

4. The method of claim 1, wherein the message authentication code is a 6 character alphanumeric character string.

5. The method of claim 1, wherein the payment verification code is an 8 character alphanumeric string.

6. The method of claim 1, wherein the nonce is a 2 digit alphanumeric character string.

7. The method of claim 1, wherein the generating of the payment verification code comprises: encoding the message authentication code using Base32 encoding.

8. The method of claim 1, wherein request is received from a first client terminal and the response is provided to a second client terminal.

9. A method for verifying authorization for package transfer, the method comprising:
scanning attribute data from a package using optical character recognition, the package containing attribute data and a payment verification code on at least one face;
applying a message authentication code algorithm to the attribute data using a software key to reproduce an encoded message authentication code;
comparing the reproduced message authentication code to the payment verification code on the at least one face of the package; and
verifying that transfer of the package is authorized based on the comparing.

10. The method of claim 9, wherein the attribute data includes at least one of a postage value, an address, and a date.

11. The method of claim 9, wherein the scanned payment verification code is hand-written on the face of the package to be transferred.

12. The method of claim 9, wherein the scanning comprises:
processing the scanned attribute data to identify distinct text components using relative positioning of each text component.

13. The method of claim 12, wherein the distinct text components include at least one of a postage value, a mailing date, a street address, a city and state, a zip code, and the payment verification code.

14. The method of claim 9, wherein the message authentication code is encoded in base-32 alphanumeric characters.

15. The method of claim 9, wherein the message authentication code algorithm is configured to generate a 30-bit message authentication code.

16. The method of claim 9, wherein the message authentication code algorithm is configured to generate a 40-bit message authentication code.

17. A payment verification device comprising:
an optical character recognition (OCR) reader configured to interpret text on at least one face of an package; and
a processing device configured to:
concatenate the interpreted text;
apply a software key code over the concatenated text;
generate a payment verification code based upon the attribute data;
compare the generated payment verification code to a payment verification code, the payment verification code appearing on a face of the package; and
determine that transfer of the package is authorized based upon the comparison.

18. The payment verification device of claim 17, wherein the OCR reader is configured to interpret at least attribute data and a payment verification code from the at least one face of the package.

19. The payment verification device of claim 18, wherein the processing device concatenates the attribute data and does not concatenate the payment verification code.

20. The payment verification device of claim 18, wherein the OCR reader is configured to interpret a nonce value from the at least one face of the package and wherein the processing device uses the nonce value to generate the payment verification code.

21. A non-transitory computer-readable storage medium storing instructions which, when executed by a hardware processor of a computing device, cause the hardware processor to perform a method for controlling at least one operation of the computing device, the computing device including a memory device having computer-readable instructions tangibly recorded thereon and a hardware processor configured to execute the computer-readable instructions recorded stored on the memory device, the method comprising:
receiving, from a user, a request for a payment verification code, the request for the payment verification code including at least attribute data related to a package,
identifying a payment verification code, the payment verification code being based upon a result of applying a message authentication code algorithm to the received attribute data and representing payment having been provided for the package,
providing, to the user, the payment verification code and a nonce, the payment verification code and the nonce being produced for addition to a face of the package.

22. The non-transitory computer-readable storage medium of claim 21, wherein the computing device is a mobile computing device or a stand-alone kiosk.

23. The non-transitory computer-readable storage medium of claim 21, wherein the request for the payment verification code includes payment information of the user.

24. A mobile computing device, comprising:
a hardware processor; and
a memory,
wherein the mobile computing device is configured to execute instructions stored on a non-transitory computer-readable storage medium which, when executed by the hardware processor, cause the hardware processor to perform a method for controlling at least one operation of the mobile computing device, the method comprising:
receiving, from a user, a request for a payment verification code, the request for the payment verification code including at least attribute data related to a package,
identifying a payment verification code, the payment verification code being based upon a result of applying a message authentication code algorithm to the received attribute data and representing payment having been provided for the package,
providing, to the user, the payment verification code and a nonce, the payment verification code and the nonce being produced for addition to a face of the package.

25. The mobile computing device of claim 24, wherein the mobile computing device stores the instructions in the memory.

26. The mobile computing device of claim 24, wherein the mobile computing device is configured to load the instructions from the non-transitory computer-readable storage medium into the memory device.

27. A method for providing payment for package transfer, the method comprising:
transmitting, via the Internet, a request for a payment verification code, the request for the payment verification code including at least attribute data related to a package to be transferred; and
receiving, in response to the transmitted request, a payment verification code and a nonce, the payment verification code being based upon a result of applying a message authentication code algorithm to the transmitted attribute data and representing payment having been provided for the package; and
marking at least one face of the package to be transferred with the received payment verification code and the nonce.

28. The method of claim 27, wherein the transmitted request includes payment information.

29. A computer system comprising:
a memory configured to store non-transitory computer-readable instructions for applying a message authentication code algorithm to received data and a software key; and
a hardware processor configured to:
receive, via the Internet, a request for a payment verification code, the request for the payment verification code including at least attribute data related to a package to be transferred;
apply the message authentication code algorithm over the received attribute data using a software key;
generate the payment verification code based upon the applied message authentication code algorithm, the payment verification code representing payment having been provided for the package to be transferred; and
transmit, via the Internet, the generated payment verification code and a nonce, the generated payment verification code and the nonce being produced for addition to a face of the package to be transferred.
